(19) United States
(12) Patent Application Publication
(10) Pub. No.: US 2008/0007201 A1
(43) Pub. Date: Jan. 10, 2008

(54) Accumulator arrangement

(76) Inventors: Bernhard Riegel, Brilon (DE); Detlef Ohms, Gottingen (DE); Rainer Markolf, Twistetal (DE); Eduardo Cattaneo, Brilon (DE)

Correspondence Address: HARNESS, DICKEY & PIERCE, P.L.C., P.O. BOX 828, BLOOMFIELD HILLS, MI, 48303, US

(21) Appl. No.: 11/801,743

(22) Filed: May 10, 2007

(30) Foreign Application Priority Data
May 11, 2006 (EP) 06009742.5

(51) Int. Cl. H02J 7/00

(52) U.S. Cl. 320/103; 320/107; 320/126

(57) ABSTRACT

The present invention relates to an accumulator arrangement with accumulators that can be operated in parallel, and also to a method for operating the accumulator arrangement according to the invention. The present invention is based on the problem of improving the exploitation of the capacity of an accumulator and of accumulator arrangements. As a solution the present invention proposes that the accumulator arrangement is configured in such a way that at least one lead-acid accumulator with a large internal resistance and at least one accumulator with a basic electrolyte respectively a sealed lead accumulator with a small internal resistance are operable in parallel.

### BACKGROUND

1. Technical Field

The present invention relates to an accumulator arrangement with accumulators that can be operated in parallel and to a method for operating the accumulator arrangement according to the invention.

2. Discussion

Batteries and especially accumulators are used in many technical fields and are particularly intended for a local energy supply of electric consumers. In addition, batteries or accumulators are used in places where public energy supply is available not at all or only with insufficient reliability. Accumulators are especially used for mobile applications where the multiple use thereof, which is made possible by recharging, allows long periods of use also at a high energy consumption. Accordingly, accumulators are frequently used in the traction operation as well as in the field of uninterruptible power supply, for instance in fork lifters, lifting devices, golf caddies or the like. Accumulators are also broadly used on the automotive sector and in the field of security.

A very frequently used type of accumulator is the lead-acid accumulator which is operated for instance by hydrogen sulfide. Considering the costs, this type of accumulator has a large capacity as an energy storage as compared to other accumulator types. But a disadvantage in these accumulators is that caused by a comparatively high internal resistance which is dependent of the charging state the capacity of the accumulator cannot be completely exploited in the supply of an electric system connected to the accumulator, especially when high current loads occur at discharging conditions below approx 20% of the rated capacity.

In practice this disadvantage leads to the fact that if inexpensive accumulators are used the same must be over-dimensioned for the operation of the electrical system as intended in order to guarantee the operation of the connected electrical system as intended because this operation normally requires an appropriately constant voltage which is independent of the characteristic load and which is allowed to change only within a particular narrow voltage range.

In a plurality of applications standard accumulators are connected to each other for a parallel and/or series operation as an accumulator arrangement which is provided as such for the energy supply of the electric system. In these accumulator arrangements the problems may even grow because the individual accumulators frequently have different characteristic parameters like aging state, internal resistance, capacity and the like. And it's precisely the inexpensive accumulators which in addition to an already initially existing high internal resistance exhibit an increase in the internal resistance over the period of operation which is comparatively high and which clearly negatively influences the quality features of the accumulator arrangement. Beyond, their characteristic values frequently spread over an undesirably vast range.

One way of alleviating the problems related to the internal resistance is shown in prior art and comprises choosing the accumulator voltage or the terminal voltage of the accumulator so that it is clearly higher than the voltage required for the operation of the electric system, and the accumulator voltage is reduced to the required level by means of a series regulator. A disadvantage of this approach resides in the fact that additional and partly expensive electronic components are required and that energy is lost due to the voltage transformation.

### SUMMARY OF THE INVENTION

It is therefore an object of the present invention to improve this type of accumulators and arrangements thereof with regard to the above-mentioned problems.

Accordingly, it is possible for the first time to considerably improve the total utilization of the capacity of the accumulators or the accumulator arrangement merely by the interconnection of two accumulators. Mutually clearly different internal resistances means that the internal resistance of the accumulator with a large internal resistance is larger than that of the accumulator with a smaller internal resistance by a factor of at least 3 and preferably approximately at least 5 and most preferably within a range of approximately 5 to 25. Inexpensive lead-acid accumulators have an internal resistance of approx 7 to 12 mΩ, hence a large internal resistance, for an accumulator capacity of approx 50 Ah. On the other hand, accumulators with a basic electrolyte for instance, such as nickel-cadmium accumulators, have an internal resistance within a range of 0.5 mΩ or smaller, which value is considered a small internal resistance. But also the structure of the accumulator itself influences the internal resistance, so that according to the invention it is basically important that an accumulator with a large internal resistance can be operated in parallel with an accumulator with a small internal resistance. Among the expensive lead accumulators with a small internal resistance there are the sealed absorbed glass mat valve regulated lead accumulators (VRLA-AGM) having a prismatic or winding cell structure.

The internal resistance defines the extent to which the accumulator voltage decreases under load, i.e. during current consumption. Accordingly, with a high current consumption the terminal voltage of the accumulator clearly decreases compared to the no-load voltage. Since during the discharging of an accumulator its terminal voltage anyway slowly decreases with an increasing discharge, it seems that an accumulator with a high internal resistance is discharged more rapidly than an accumulator with a small internal resistance, even if their nominal capacities are equal. This problem can be overcome only by the invention, namely by connecting an accumulator with a small internal resistance in parallel with an already existing accumulator with a high internal resistance. Depending on the configuration, this parallel connection may be effected directly or there may be provided additional control means by which the parallel operation can be controlled. It may be provided for instance that during a high current discharge phase the energy supply takes place preferably from the accumulator with the small internal resistance and that during a phase of low current consumption this accumulator is successively recharged by the accumulator with the high internal resistance. Therefore, the capacities of the two accumulators or of the accumulator arrangement must be selected in dependence of the requirements of the energy supply with regard to the electric system.

Preferably, the accumulators all have an equal terminal voltage, so that they can be directly operated in parallel. A high availability of the energy supply can be attained, especially because the whole storage capacity can be exploited much better by the accumulator arrangement according to the invention.

An accumulator that can be used in a vast range of applications is the lead-acid accumulator. A for instance sealed lead-acid accumulator having a conventional structure comprising a wet electrolyte is outstanding especially by its inexpensive production paired with an attainable high capacity. Inexpensive lead-acid accumulators frequently have a high internal resistance. But of course, also lead-acid accumulators with a small internal resistance are available, but these are more expensive than lead-acid accumulators with a small internal resistance. Therefore, by a suitable combination of such accumulators the availability of the energy supply can be improved.

Also conceivable is the use of an accumulator comprising a basic electrolyte. Accumulators having basic electrolytes often have a small internal resistance, but they are more expensive compared to lead-acid accumulators having the same capacity. With the present invention it is now proposed that such accumulators are able to be operated in parallel with lead-acid accumulators that have a high internal resistance. By appropriately selecting the terminal voltage and the accumulator capacities it is possible to obtain an improvement of the availability of the energy supply. Accordingly, it may be provided that a high current energy supply period is mastered by an accumulator comprising a basic electrolyte, and that the same is rechargeable by the lead-acid accumulator during a period of small energy consumption. For instance, said basic electrolyte can be an electrolyte on an alkaline basis such as K—OH for example.

In a further embodiment it is provided that the accumulator with a small internal resistance is an accumulator that comprises a basic electrolyte, in particular a nickel-metal-hybrid or nickel-cadmium accumulator. Such accumulators are commercially available. Compared to lead-acid accumulators they have a small internal resistance and a high cycle use. Accordingly, inexpensive and reliable series production accumulators with a small internal resistance can be used. It's precisely the nickel-cadmium accumulators that are outstanding by their high degree of reliability and constancy of parameters during their operation as intended. Furthermore, such accumulators are adapted for high current charging, which fact is also utilized by the present invention. In an embodiment in which for instance a lead-acid accumulator with a high capacity is connected in parallel with a nickel-cadmium accumulator with a low capacity, a small discharging current of the lead-acid accumulator corresponds to a large charging current of the nickel-cadmium accumulator. Thereby it can be attained that the discharging current which is small relative to the lead-acid accumulator and which at the same time is the charging current of the nickel-cadmium accumulator can charge the nickel-cadmium accumulator in the way as intended. In this context it turned out as advantageous that nickel-cadmium accumulators can be charged also with high charging currents.

It is further proposed that at least one electrode of an accumulator is formed by a fibre structure electrode. The fibre structure electrode can smaller the internal resistance of the accumulator, and especially it can reduce the internal resistance of the accumulator by reducing the electric resistance of the electrode due to the shorter distance between active mass and the current conductors that consist of electrically conductive and in particular nickel-plated fibres. In this way it is possible not only to reduce energy losses within the accumulators but also to obtain a more stable voltage at the terminals under load.

In a further embodiment it is proposed that an accumulator is a lithium-ion accumulator. Normally, the lithium-ion accumulator has a high power rating at a large internal resistance. Accordingly, its parameters are almost constant during its operation as intended and its energy density is clearly higher as compared to conventional accumulators. In order to better utilize the advantages offered by the lithium-ion accumulator the same may be operated for instance in parallel with a nickel-cadmium accumulator, in order to reduce the disadvantage of the large internal resistance.

It is further proposed that a number of cells of the accumulators comprising a basic electrolyte are smaller or equal to twice the number of cells of the lead-acid accumulator. By an appropriate selection of the cells it can be obtained that the accumulators are directly connected in parallel operation. Switching means for separating individual accumulators as well as control means can be omitted.

In a further embodiment it is proposed that the capacity of the accumulator with the small internal resistance amounts to approx 5% to 70% and preferably 10% to 50% and still more preferably 15% to 35% of the capacity of the accumulator with the large internal resistance. The costs for the accumulator arrangement can be reduced, especially because frequently the accumulator with the small internal resistance and with a comparable capacity is more expensive than an accumulator with a large internal resistance.

In addition it is proposed that the accumulator arrangement comprises a control unit. By the control unit which is provided for instance in the form of an energy management and/or operation monitoring unit it can be obtained that the accumulator arrangement as such makes an optimum operation possible and this also for each individual accumulator. So it may be provided that charging and discharging periods are individually predetermined for single accumulators of the accumulator arrangement.

It is further proposed that the accumulator includes a computer unit. The computer unit can be configured as an arithmetic and data storage unit and can be additionally controlled by a micro processor. With the computer unit it can be attained that accumulator operation flows as intended can be automated. The operation flows can be provided for example in the form of a computer program based on algorithms with battery-specific data in the computer unit. Easy adaptation to a desired operation is obtainable thereby merely by correspondingly adapting the computer program and/or by loading the corresponding charging characteristic for the charging device.

Further it is proposed that the accumulator arrangement includes a controllable switching unit. The switching unit may be provided for the switching connection of individual accumulators or also of the entire accumulator arrangement to the connected electric system. So it may be provided that in dependence of the energy required by the electric system individual accumulators can be connected or disconnected. An optimisation of the operation for each accumulator arrangement and for each individual accumulator can be attained.

According to a further development it is provided that the switching unit is connectible to a charging unit. In this way it is obtainable for the accumulators of the accumulator arrangement to be charged according to needs. It may be provided for instance that individual cut-off accumulators during their cut-off period are connected to the charging device for being charged.

In addition it is proposed that the charging unit includes adjustable charging characteristics. This makes it possible for each accumulator to be charged individually in dependence of its accumulator properties. Accordingly, for a lead-acid accumulator a charging characteristic can be provided which is different from that which is provided for a nickel-cadmium accumulator.

According to a further development of the present invention it is proposed that the accumulator arrangement includes a frame. The frame makes it possible to combine the accumulators of the accumulator arrangement to one assembly which is electrically connected as intended. In addition, the arrangement in a frame makes easy handling possible, especially in vehicles, as well as an easy replacement.

It is further provided that the frame includes a handle. By means of said handle the manual handling of the frame is made easier.

Furthermore it is proposed that the accumulator arrangement includes quick-connecting contacts. Thereby it is obtained that for instance in traction vehicles a quick exchange of the accumulator arrangement for a charged accumulator arrangement is possible, whereby the availability of the vehicle can be improved.

According to a further development it is proposed that the accumulator arrangement includes an operating condition indicator. Accordingly it can be provided for instance that the charging condition of the accumulator arrangement or of individual accumulators is indicated. But it can also be provided that the terminal voltage or a discharging and/or charging current are indicated.

With the present invention there is also proposed a method for operating the accumulator arrangement according to the invention, wherein at least two accumulators with mutually clearly different internal resistances are operated in parallel for the energy supply of an electric system that can be connected to the accumulator arrangement. An inexpensive accumulator arrangement can be achieved which makes it possible to obtain a good exploitation of the electric capacity of the accumulators.

It is further proposed that the energy supply of the electric system is substantially affected through the accumulator with the smaller internal resistance. Thereby it can be achieved that the voltage supply of the electric system has a constant voltage. Voltage fluctuations due to load changes can be reduced.

It is further proposed that a state variable of the accumulator is detected. As a state variable there can be detected for example a characteristic parameter of the accumulator such as the electric capacity, temperature, electrolyte filling level, electric voltage or the charging condition of the accumulator. To this end the accumulator arrangement can be provided with suitable sensors by which the state variables are detectable.

Additionally, it is proposed that the state variable is memorized. In this way the state variable can be kept available for interrogation. This embodiment is particularly advantageous in mobile applications, where the accumulator arrangement is not accessible during its operation as intended.

It is further proposed that the state variable is transmitted to a central terminal. The transmission can take place for instance via radio or the like. In this way the central terminal can keep the state variable of the accumulator arrangement and initiate measures upon reaching predetermined thresholds. Accordingly, it can be provided that if the charging state drops below a predetermined charging condition of the accumulator arrangement of a vehicle, the accumulator arrangement must either be replaced for a charged accumulator arrangement or recharged as soon as possible.

According to a further development it is provided that the accumulator with the small internal resistance is charged by the accumulator with the large internal resistance. Thereby it can be achieved that the capacity for the accumulator with the small internal resistance can be kept smaller than the capacity for the accumulator with the large internal resistance. Costs can be saved.

In a further embodiment it is provided that the discharging and/or charging of the accumulators is controlled by means of a control unit. In a traction vehicle the accumulator with the large internal resistance is provided for the base load operation and the high power accumulator with the small internal resistance is provided for peak loads. To this end the control unit includes a current measuring unit and provides for the preservation of a minimum charge for reaching the next charging station. It is made possible thereby not only to achieve the optimum availability of the accumulator arrangement but each accumulator arrangement can also be charged optimally according to its characteristic. A high reliability throughout the intended service life can be reached.

Moreover, it is provided that the discharging and/or charging of the accumulators is controlled in dependence of the state variable. It can be provided for instance that in the case of a value dropping below a voltage threshold or a charge threshold of the accumulator or the accumulator arrangement the charging of the accumulators or the accumulator arrangement is caused. The availability of the accumulator arrangement can be further improved.

### BRIEF DESCRIPTION OF THE DRAWINGS

Further advantages and features will become apparent from the following description of one embodiment. Similar components are identified by same reference numbers. The drawing is a schematic drawing and merely serves for explaining the following embodiment.

FIG. 1 shows an accumulator arrangement according to the present invention comprising two accumulators in parallel operation.

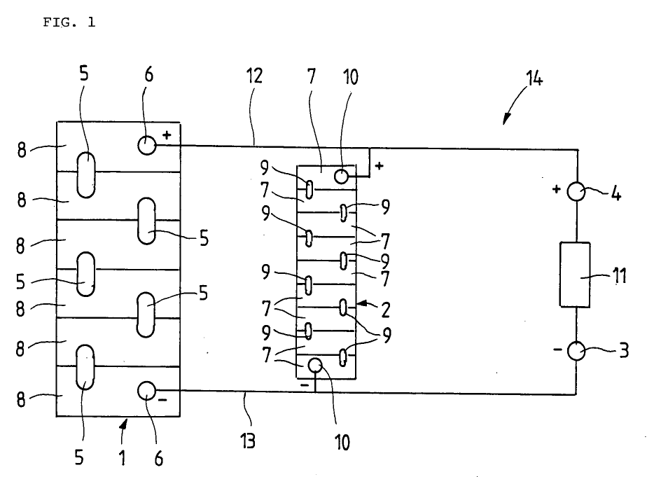

### DESCRIPTION OF THE PREFERRED EMBODIMENTS

The single drawing figure shows a lead-acid accumulator using sulphuric acid as an acid. The lead-acid accumulator 1 consists of six series-connected accumulator cells 8, with the series connection being established by connecting the corresponding poles through electrically conductive bridges 5. The accumulator 1 includes two terminals 6, one each for the positive pole and the negative pole. The drawing figure further shows a nickel-cadmium accumulator 2 which is formed from nine cells 7. The cells 7 are electrically interconnected in series by means of bridges 9. The accumulator 2 has two terminals 10, one each for the positive pole and the negative pole. Through lines 12, 13 the positive poles 6, 10 of the accumulators 1, 2 are connected to the positive connection pole 4 of the accumulator arrangement 14. Correspondingly, the negative poles 6, 10 of the accumulators 1, 2 are connected to the negative connection pole of the accumulator arrangement 14. Accordingly, the two accumulators 1, 2 are in parallel operation.

Conventionally, a lead-acid accumulator is considered as discharged if its cell voltage reaches the value of 1.83 V. Relating to the accumulator 1 this means a terminal voltage between the terminals 6 of 10.98 V.

During the operation the accumulator 2 has a cell voltage of 1.2 V which corresponds to a voltage between the terminals 10 of 10.8 V. Accordingly, in the present embodiment both accumulators have approximately an equal voltage.

In the present embodiment the accumulator 1 has a capacity of 48 Ah. Compared to that the accumulator 2 has a capacity of 11 Ah.

The accumulator 1 further has an internal resistance of 9 mΩ. On the other hand, the accumulator 2 has an internal resistance of 0.1 mΩ.

If in the present embodiment a current of 100 A is consumed by the electric system 11 this would cause a voltage drop of approx 0.9 V at the internal resistance of this accumulator 1, applying Ohm's law, if the energy supply took place alone by accumulator 1. This corresponds to nearly 10% of the terminal voltage between the terminals 6 of the accumulator 1. Since at a terminal voltage of 10.98 V the accumulator 1 is already considered as discharged, this voltage drop would lead to that the remaining capacity of the accumulator 1 would not be exploited any longer as soon as a voltage of approx 11.88 V is reached.

On the other hand, if the current were provided by the accumulator 2 this would lead to a voltage drop of approx 0.1 V, taking the above figures into account. This approximately corresponds to a voltage break-in of 1%. This calculation already clearly shows that the accumulator 2 causes a substantially higher stability concerning the voltage supply of the electric system 11.

The interconnection according to the drawing figure leads to that the current is divided to both accumulators 1 and 2. Taking the internal resistances into account, this division results in approx 1:9, meaning that approx 10 A of discharging current are taken from accumulator 1, whereas approx 90 A of discharging current are taken from accumulator 2. This results in a voltage drop of approx 0.1 V at the internal resistance of accumulator 1 and also in a voltage drop of approx 0.1 V at the internal resistance of accumulator 2. Accordingly, in the present interconnection a voltage break-in of approx 0.1 V is caused during the intended discharging current. This corresponds to approx 1% of the supply voltage. Consequently, the result is that the capacity of the accumulator 1 can be exploited almost up to the maximum voltage of 10.98 V.

If the current requirement by the electric system 11 is reduced or adjusted, the charging of the accumulator 2 will take place through the accumulator 1. This is important because of the fact that due to the higher energy consumption the accumulator 2 is discharged clearly to a larger extent than the accumulator 1. In addition, the accumulator 2 clearly has a smaller capacity than the accumulator 1.

In case of a charging current of 10 A from accumulator 1 into accumulator 2, which corresponds to a preferred quick charging of the accumulator 2, the break-in of the voltage now takes place essentially through the higher internal resistance of the accumulator 1. The voltage drop across the internal resistance of the accumulator 2 is negligibly small in this embodiment. Accordingly, a voltage drop of again approx 0.1 V has to be estimated. However, compared to the terminal voltage this is within a range of approx 1%, resulting in that the accumulator 2 is charged by the accumulator 1 in the way according to the invention. Thereby the capacity of the accumulator 1 can be exploited much better than this would be possible without the connection to the accumulator 2 in the accumulator arrangement 14. The accumulator 2 is charged again after a relatively short time and is available for the next high current requirement.

Though the above-described example is provided for the discharge of an accumulator arrangement, it may be provided in a dual fashion also for receiving an electrical charge or for a charging operation.

In order to make the internal resistance of the accumulator especially small, it is provided that the electrodes of the accumulator 2 are formed as fibre structure electrodes.

The number of cells of the accumulator 2 is chosen so that its nominal voltage is below the nominal voltage of the accumulator 1.

The respective rating of the capacities of the accumulators can be adapted to the respective technical requirements.

The example shown in the drawing figure merely serves for explaining the invention and is not in any way limiting to the invention. Especially the number of accumulators that are used, the types of the accumulators that are used, the number of cells and the like may vary, without departing from the spirit and the scope of the invention.

What is claimed is:

1. An accumulator arrangement comprising:
accumulators which are adapted for parallel operation, and
wherein the accumulator arrangement is configured in such a way that at least two accumulators are operable in parallel, with internal resistances that a clearly different from each other.

2. The accumulator arrangement according to claim 1, wherein the accumulator with a small internal resistance is an accumulator having a basic electrolyte, especially a nickel-metal hydride or nickel-cadmium accumulator.

3. The accumulator arrangement according to claim 1 wherein the accumulator with the small internal resistance is a maintenance-free glass mat lead accumulator having a prismatic or winding cell structure.

4. The accumulator arrangement according to claim 1 wherein one electrode at least of an accumulator is formed by a fibre structure electrode.

5. The accumulator arrangement according to claim 1 wherein one accumulator is a lithium-ion accumulator.

6. The accumulator arrangement according to claim 1 wherein a number of cells of the accumulator having the basic electrolyte is smaller than or equal to twice the number of cells of the lead-acid accumulator.

7. The accumulator arrangement according to claim 1 wherein the capacity of the accumulator with the smaller internal resistance amounts to approx 5% to 70%, preferably 10% to 50% and most preferably 15% to 35% of the capacity of the accumulator with the larger internal resistance.

8. The accumulator arrangement according to claim 1 further comprising a control unit.

9. The accumulator arrangement according to claim 1 further comprising a computer unit.

10. The accumulator arrangement according to claim 1 further comprising a controllable switching unit.

11. The accumulator arrangement according to claim 10 wherein the switching unit is connectible to a charging unit.

12. The accumulator arrangement according to claim 11 wherein the charging unit has adjustable charging characteristics.

13. The accumulator arrangement according to claim 1 further comprising a frame.

14. The accumulator arrangement according to claim 13 wherein the frame includes a handle.

15. The accumulator arrangement according to claim 1 further comprising quick-connecting contacts.

16. The accumulator arrangement according to claim 1 further comprising an operating condition indicator.

17. A method for operating an accumulator arrangement comprising operating at least two accumulators with mutually clearly different internal resistances in parallel for the energy supply of an electric system which is connectible to the accumulator arrangement.

18. The method according to claim 17 wherein the energy supply of the electric system takes place substantially through the accumulator with the small internal resistance.

19. The method according to claim 17 wherein a state variable of the accumulator is detected.

20. The method according to claim 19 wherein the state variable is memorized.

21. The method according to claim 17 wherein the accumulator with the smaller internal resistance is charged by the accumulator with the larger internal resistance.

22. The method according to claim 17 wherein discharging and/or charging of the accumulators is controlled by means of a control unit.

23. The method according to claim 20 wherein discharging and/or charging of the accumulators is controlled in dependence of the state variable.
